(19) United States
(12) Patent Application Publication
(10) Pub. No.: US 2008/0179840 A1
(43) Pub. Date: Jul. 31, 2008

(54) Chuck device for a hand tool

(76) Inventor: Chin-Tan Huang, Taichung Hsien (TW)

Correspondence Address: LADAS & PARRY, 5670 WILSHIRE BOULEVARD, SUITE 2100, LOS ANGELES, CA, 90036-5679, US

(21) Appl. No.: 11/700,368

(22) Filed: Jan. 31, 2007

(51) Int. Cl. B23B 31/16

(52) U.S. Cl. 279/74

(57) ABSTRACT

A chuck device for a hand tool includes a socket and an engaging piece. The socket defines a shank-receiving groove, and is formed with a through-hole that is in spatial communication with the shank-receiving groove. The engaging piece is disposed movably in the through-hole in the socket, has a tapered end, and is movable relative to the socket between an engaging position, where the tapered end thereof is disposed in the shank-receiving groove in the socket, and a disengaging position, where the tapered end thereof is disposed out of the shank-receiving groove in the socket.

### BACKGROUND OF THE INVENTION

1. Field of the Invention

The invention relates to a chuck device, more particularly to a chuck device that reliably secures a tool bit to a handle of a hand tool.

2. Description of the Related Art

FIG. 1 illustrates a conventional chuck device that includes a socket 1, a detent ball 2, a sleeve 7, and a biasing member 4.

The conventional chuck device serves to secure a tool bit 5 to a handle 61 of a hand tool 6.

The tool bit 5 has a tip 502, and a shank 501 that extends from the tip 502 thereof, that has a hexagonal cross-section, and that has six corners, each of which is formed with a tapered groove 500.

The socket 1 is connected to an end of the handle 61 of the hand tool 6, defines an axially extending shank-receiving groove 101, which has a hexagonal cross section and into which the shank 501 of the tool bit 5 is inserted, and is formed with a radially extending through-hole 102, which is in spatial communication with the shank-receiving groove 101.

The detent ball 2 is disposed movably in the through-hole 102 in the socket 1, and is movable relative to the socket 1 between an engaging position, where the detent ball 2 extends into the shank-receiving groove 101 in the socket 1, and a disengaging position, where the detent ball 2 is disposed out of the shank-receiving groove 101 in the socket 1.

The sleeve 7 is sleeved movably on the socket 1, and has a first end portion 701, and a second end portion 702 which is opposite to and which has a larger diameter than that of the first end portion 701 of the sleeve 7. The sleeve 7 is movable relative to the socket 1 in a first axial direction, as indicated by arrow (A), for aligning the second end portion 702 of the sleeve 7 with the through hole 102 in the socket 1 to thereby permit movement of the detent ball 2 to the disengaging position, and thus extension of the detent ball 2 into a gap between the second end portion 702 of the sleeve 7 and the socket 1, and in a second axial direction opposite to the first axial direction, as indicated by arrow (B), for aligning the first end portion 701 of the sleeve 7 with the through hole 102 in the socket 1 to thereby permit the first end portion 701 of the sleeve 7 to push the detent ball 2, and thus cause movement of the detent ball 2 to the engaging position.

The biasing member 4 is sleeved on the socket 1, and has opposite ends that respectively abut against the sleeve 7 and the socket 1 for biasing movement of the sleeve 7 in the second axial direction.

In use, when it is desired to secure the tool bit 5 to the handle 61 of the hand tool 6, the sleeve 7 is first moved in the first axial direction against biasing action of the biasing member 4 until the second end portion 702 of the sleeve 7 is aligned with the through-hole 102 in the socket 1. Then, the shank 501 of the tool bit 5 is inserted into the shank-receiving groove 101 and pushes against the detent ball 2 to thereby cause movement of the detent ball 2 to the disengaging position. Thereafter, the sleeve 7 is moved in the second axial direction to thereby permit the detent ball 2 to engage one of the tapered grooves 500 in the shank 501 of the tool bit 5.

The aforementioned conventional chuck device is disadvantageous in that, as best shown in FIG. 2, a gap exists between the detent ball 2 and the tapered groove 500 in the shank 501 of the tool bit 5 when the conventional chuck device secures the tool bit 5 to the handle 61 of the hand tool 6. As such, the tool bit 5 may not be reliably secured to the handle 61 of the hand tool 6.

### SUMMARY OF THE INVENTION

Therefore, the object of the present invention is to provide a chuck device that can overcome the aforesaid drawback of the prior art.

According to the present invention, a chuck device for a hand tool comprises a socket and an engaging piece. The socket defines an axially extending shank-receiving groove, and is formed with a radially extending through-hole that is in spatial communication with the shank-receiving groove. The engaging piece is disposed movably in the through-hole in the socket, has a tapered end, and is movable relative to the socket between an engaging position, where the tapered end thereof is disposed in the shank-receiving groove in the socket, and a disengaging position, where the tapered end thereof is disposed out of the shank-receiving groove in the socket.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional chuck device;

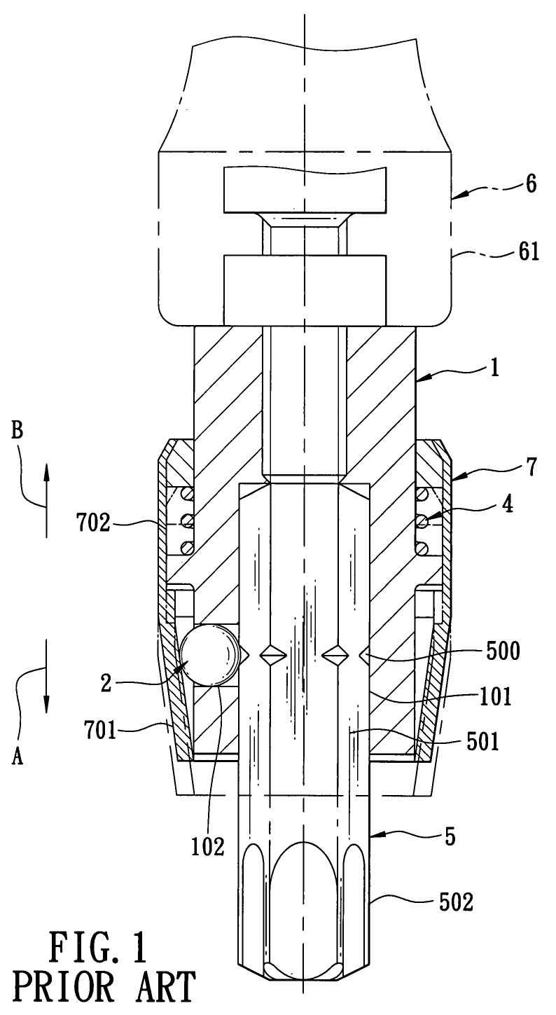

FIG. 2 is a cutaway sectional view to illustrate a state where a detent ball of the conventional chuck device engages a tapered groove of a tool bit;

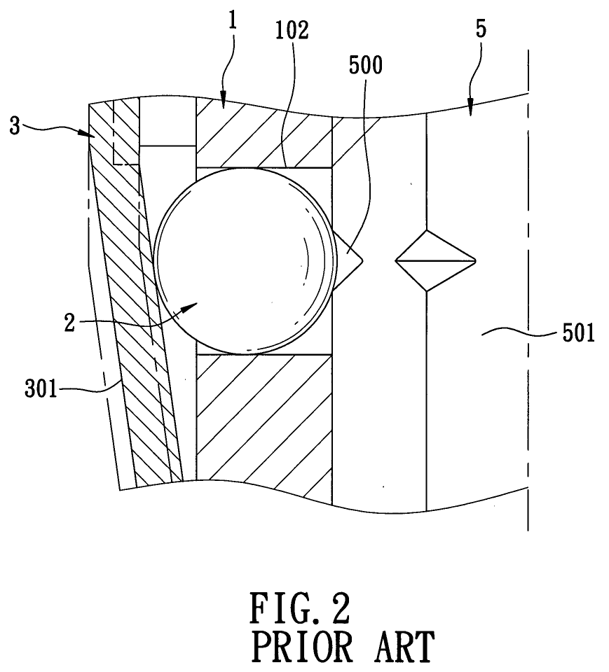

FIG. 3 is a sectional view of the preferred embodiment of a chuck device according to the present invention;

FIG. 4 is a perspective view to illustrate an engaging piece of the preferred embodiment;

FIG. 5 is a sectional view to illustrate a state where the engaging piece of the preferred embodiment is disposed at a disengaging position; and

FIG. 6 is a sectional view to illustrate a state where the engaging piece of the preferred embodiment is disposed at an engaging position.

### DETAILED DESCRIPTION OF THE PREFERRED EMBODIMENT

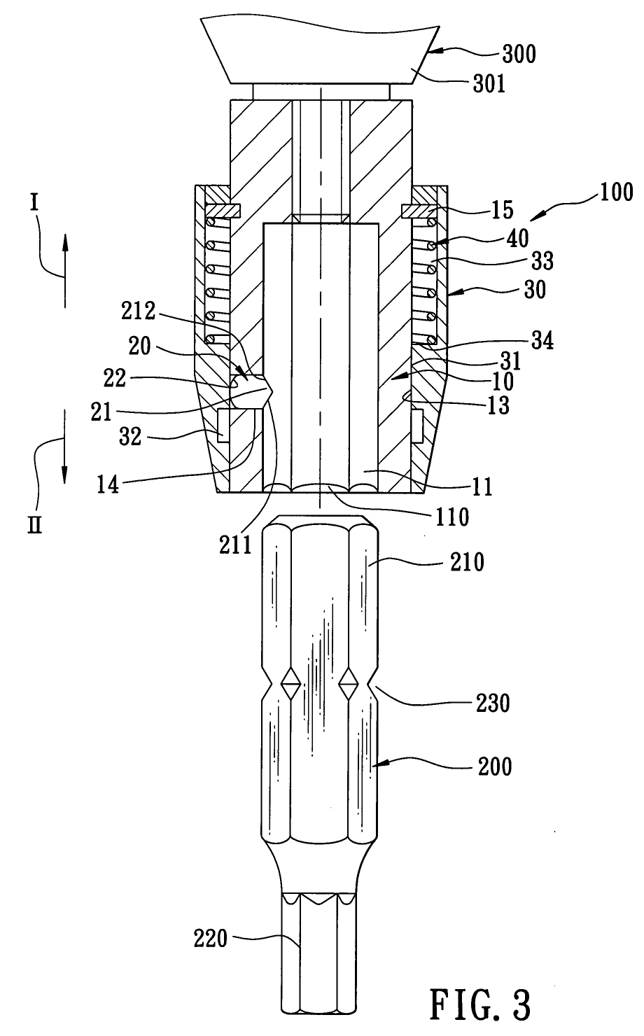

Referring to FIG. 3, the preferred embodiment of a chuck device 100 according to this invention is shown to include a socket 10 and an engaging piece 20.

The chuck device 100 of this embodiment serves to secure a tool bit 200 to a handle 301 of a hand tool 300, in a manner that will be described hereinafter.

The tool bit 200 has a tip 220, and a shank 210 that extends from the tip 220 thereof, that has a hexagonal cross section, and that has six corners, each of which is formed with a tapered groove 230.

The socket 10 is connected to an end of the handle 301 of the hand tool 300, defines an axially extending shank-receiving groove 11, and is formed with a radially extending through-hole 14 that is in spatial communication with the shank-receiving groove 11. In this embodiment, the shank-receiving groove 11 has a hexagonal cross section to thereby permit insertion of the shank 210 of the tool bit 200 thereinto.

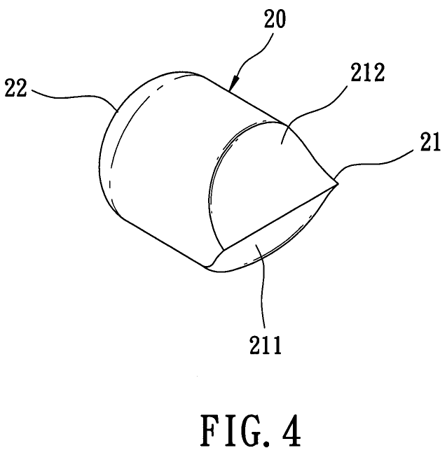

With further reference to FIG. 4, the engaging piece 20 is disposed movably in the through-hole 14 in the socket 10, and has opposite rounded and tapered ends 22, 21. In this embodiment, the tapered end 21 of the engaging piece 20 has a V-shaped cross section, and first and second sides 211, 212 that are opposite to each other in an axial direction.

The engaging piece 20 is movable relative to the socket 10 between an engaging position, where the tapered end 21 thereof is disposed in the shank-receiving groove 11 in the socket 10, and a disengaging position, where the tapered end 21 thereof is disposed out of the shank-receiving groove 11 in the socket 10.

The chuck device 100 further includes a sleeve 30 that is sleeved movably on an outer surface 13 of the socket 10. In this embodiment, the sleeve 30 has an inner surface 31 that is formed with first and second annular recesses 32, 33 so as to define an annular shoulder 34 therebetween.

The sleeve 30 is movable relative to the socket 10 between a first axial direction, as indicated by arrow (I), for aligning the first annular recess 32 in the inner surface 31 of the sleeve 30 with the through-hole 14 in the socket 10 to thereby permit movement of the engaging piece 20 to the disengaging position, and thus extension of the rounded end 22 of the engaging piece 20 into the first annular recess 32, and in a second axial direction, as indicated by arrow (II), for aligning the annular shoulder 34 of the inner surface 31 of the sleeve 30 with the through-hole 14 in the socket 10 to thereby permit the shoulder 34 to push the rounded end 22 of the engaging piece 20, and thus cause movement of the engaging piece 20 to the engaging position.

The chuck device 100 further includes a biasing member 40 for biasing movement of the sleeve 30 in the second axial direction. In particular, the outer surface 13 of the socket 10 is further provided with a radially and outwardly extending annular flange 15 that extends into the second annular recess 33 in the socket 10. The biasing member 40, such as a coil spring, is sleeved on the socket 10, is disposed in the second annular recess 33 in the sleeve 30, and has opposite ends that respectively abut against the shoulder 34 of the inner surface 31 of the sleeve 30 and the annular flange 15 of the outer surface 13 of the socket 10.

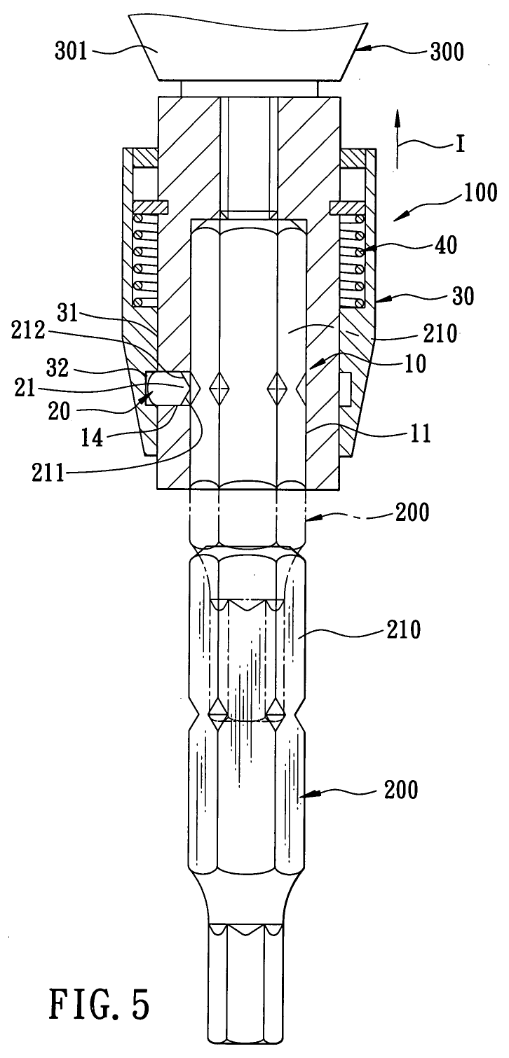

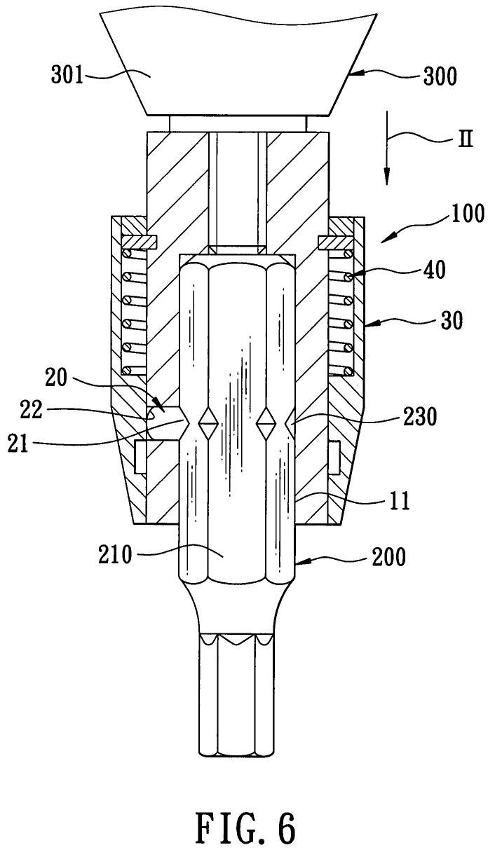

In use, when it is desired to secure the tool bit 200 to the handle 301 of the hand tool 300, as best shown in FIG. 5, the sleeve 30 is first moved in the first axial direction (I) against biasing action of the biasing member 40 until the first annular recess 32 in the inner surface 31 of the sleeve 30 is aligned with the through-hole 14 in the socket 10. Then, the shank 210 of the tool bit 200 is inserted into the shank-receiving groove 11 in the socket 10, and pushes against the first side 211 of the tapered end 21 of the engaging piece 20 to thereby cause movement of the engaging piece 20 to the disengaging position. Thereafter, as best shown in FIG. 6, the sleeve 30 is moved in the second axial direction (II) to thereby permit the engaging piece 20 to engage one of the tapered grooves 230 in the shank 210 of the tool bit 200, thus securing the tool bit 200 to the handle 301 of the hand tool 300.

It is noted that, since the tapered end 21 of the of the engaging piece 20 has a shape that corresponds to that of each of the tapered grooves 230 in the shank 210 of the tool bit 200, the tapered end 21 of the engaging piece 20 extends fittingly into one of the tapered grooves 230 in the shank 210 of the tool bit 200 when the chuck device 100 of this invention secures the tool bit 200 to the handle 301 of the hand tool 300. That is, physical contact between the engaging piece 20 of the chuck device 100 of this invention and the tool bit 200 is relatively large when the chuck device 100 of this invention secures the tool bit 200 to the handle 301 of the hand tool 300. As such, it is ensured that the tool bit 200 is reliably secured to the handle 301 of the hand tool 300.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A chuck device for a hand tool, comprising:
a socket defining an axially extending shank-receiving groove, and formed with a radially extending through-hole that is in spatial communication with said shank-receiving groove; and
an engaging piece disposed movably in said through-hole in said socket, and having a tapered end, said engaging piece being movable relative to said socket between an engaging position, where said tapered end thereof is disposed in said shank-receiving groove in said socket, and a disengaging position, where said tapered end thereof is disposed out of said shank-receiving groove in said socket.

2. The chuck device as claimed in claim 1, wherein said tapered end of said engaging piece has a V-shaped cross-section.

3. The chuck device as claimed in claim 1, wherein said tapered end of said engaging piece has first and second sides that are opposite to each other in an axial direction.

4. The chuck device as claimed in claim 1, wherein said engaging piece further has a rounded end that is opposite to said tapered end thereof, said chuck device further comprising a sleeve sleeved movably on said socket, and having an inner surface that is formed with a first recess so as to define a shoulder, said sleeve being movable relative to said socket in a first axial direction for aligning said first recess in said inner surface thereof with said through-hole in said socket to thereby permit movement of said engaging piece to the disengaging position, and thus extension of said rounded end of said engaging piece into said first recess, and in a second axial direction opposite to the first axial direction for aligning said shoulder of said inner surface of said sleeve with said through-hole in said socket to thereby permit said shoulder to push said rounded end of said engaging piece, and thus cause movement of said engaging piece to the engaging position.

5. The chuck device claimed in claim 4, further comprising a biasing member for biasing movement of said sleeve in the second axial direction, said biasing member being sleeved on said socket, and having opposite ends that respectively abut against said socket and said sleeve.

6. The chuck device as claimed in claim 5, wherein said inner surface of said sleeve is further formed with a second recess, said shoulder of said inner surface of said sleeve being disposed between said first and second recesses, said socket being provided with a radially and outwardly extending flange, said biasing member being disposed in said second recess in said inner surface of said sleeve, said opposite ends of said biasing member respectively abutting against said shoulder of said inner surface of said sleeve and said flange of said socket.

7. The chuck device as claimed in claim 1, wherein said shank-receiving groove in said socket has a hexagonal cross section.

8. The chuck device as claimed in claim 1, wherein said first recess is annular in shape.

9. The chuck device as claimed in claim 6, wherein each of said first and second recesses, and said flange is annular in shape.
